(19) United States
(12) Patent Application Publication
(10) Pub. No.: US 2005/0057936 A1
(43) Pub. Date: Mar. 17, 2005

(54) Wall mounted luminaire

(76) Inventors: Frank Drees, Plettenberg (DE); Ulrich Zucker, Ehringshausen (DE)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 10/844,979

(22) Filed: May 13, 2004

(30) Foreign Application Priority Data
May 13, 2003 (DE) DE103 21 282.5-54

(51) Int. Cl. F21S 8/00

(52) U.S. Cl. 362/432

(57) ABSTRACT

The invention concerns a wall mounted luminaire, in particular for producing indirect light, comprising a casing (10) for fixing to a wall and a light guide device fixed to the casing (10) for guiding a preferably indirect light flux radiated from a light means. The aim is to increase the light intensity distribution beneath the light. That is achieved according to the invention in that the light guide device is mounted rotatably to the casing (10) and that there are provided means for at least partially deflecting the light flux in the rotary movement (FIG. 1).

The invention concerns a wall mounted luminaire, in particular for producing indirect light, comprising a casing for fixing to a wall and a light guide device fixed rotatably to the casing for guiding a light flux emitted by a light means, wherein the light flux upon rotation is at least partially deflected.

Preferably luminaires of that kind are used for producing indirect light. In the present case indirect light is used to denote light which is emitted by the light means and reflected by way of a reflecting surface, for example a reflector or a ceiling.

Such a wall mounted luminaire is known for example from the present applicants' design registration DE 402 03 188. In that wall mounted luminaire the casing which is in the form of a device carrier accommodates the electrical devices for operation of the luminaire such as for example power supply units. The light guide device is in the form of a translucent hollow wing which projects from the device carrier and which is fixed at the downward end to the device carrier. A light means is arranged in the bottom of the light guide device in the form of the wing. The hollow wing guides the light flux emitted by the light means towards the ceiling.

DE 1 776 911 discloses a wall mounted luminaire having a rotatable reflector with which a fluorescent lamp can be selectively shielded in order to produce a direct and an indirect light component. Luminaires with displaceable light guide devices are also known from DE 77 19 975, EP 0 347 700 and DE 43 03 185.

Wall mounted luminaires of that kind are distinguished in the meantime by light means with a high wattage, which have to be disposed in a small installation space. That results in a not inconsiderable amount of heat being generated in the luminaire, and that heat has to be dissipated. In addition indirectly radiating wall mounted luminaires do not guarantee adequate illumination in the region beneath the luminaire, for example for illuminating emergency escape routes, for the illumination of which a luminous intensity distribution of 100 lux is required.

Therefore the object of the present invention is to so develop a wall mounted luminaire that the luminous intensity distribution can be adapted, in particular to achieve a higher level of luminous intensity distribution below the luminaire.

In accordance with the invention that object is attained in that the means include a slider which upon rotation of the light guide device selectively opens and exposes a light transmission opening in the casing. The slider selectively opens or closes a light transmission opening and thus deflects more or less light into the secondary light flux.

In that way the intensity of the deflected secondary light flux can be adjusted according to the respective needs involved in dependence on the angular position of the light guide element in relation to the casing. For example the slider can be provided on the light guide element and can expose a light transmission opening in the casing.

The secondary light flux can either be radiated as direct light directly in the desired direction, for example on to the floor, or it can be reflected by way of a reflector, as required. Thus for example it is possible to arrange in the casing a reflector on which the secondary light flux impinges. That reflector can also be adjustable.

In accordance with the invention the wall mounted luminaire can be of such a design that provided in the casing is an additional reflector which directs the secondary light flux in the desired direction, preferably downwardly. In that case the reflector can be so provided in the casing that there is a shaft-like light passage in a downward direction. That passage additionally has a chimney effect, therefore by virtue of the heat from the light means, it attracts cool air for cooling the luminaire. In that way the luminaire can be equipped with a higher wattage in comparison with a luminaire without a chimney, while being of the same structural size.

The configuration according to the invention provides that the light deflection can be adapted as required so that it is possible to implement a luminous intensity distribution of 100 lux for lighting emergency and rescue routes. In addition the pivotal movement of the light guide element simplifies replacing the light means as the light means are more easily accessible in the pivoted-open condition.

In terms of abstraction of the concept of the invention therefore the invention provides a wall mounted luminaire having a pivotable light guide element with which the luminous intensity distribution can be adapted and controlled as required.

In addition the invention concerns a detent device for fixing a light guide element mounted pivotably about an axis of rotation in various detent positions, in particular for a wall mounted luminaire, wherein the light guide element can be connected to the casing by way of at least one connecting element and there is provided a pressure element which is biased by a spring and which to implement the detent effect can be latched into one or more blind holes or the like.

Hitherto ball-type detent arrangements have usually been employed as detent devices in the luminaire art. Ball-type detent arrangements comprise a screwthreaded pin which is hollow at its inside and out of the open end of which projects a resiliently mounted pressure ball. Those ball-type detent arrangements are usually fixed in the immobile component, thus for example in the connecting element which is fitted to the casing, and act against blind holes or the like provided on the rotatable light guide element.

As described hereinbefore such a detent device has to carry high weights of the light guide element. In the development of the present invention it was found that ball-type detent arrangements which were suitable for the loads which occur in respect of the shaped light guide members cannot be fitted in the constricted structural spaces afforded by modern wall mounted luminaires which without exception are of a filigree appearance. It was also found that, with the limited structural space available in the luminaires, the ball-type detent arrangements have an excessively short spring travel in comparison with their size, in order to compensate for the tolerance differences which occur in respect of the components involved. The comparatively short spring travel means that, even with relatively small tolerance differences which can occur for example due to the components of the luminaire being painted in different ways, the ball-type detent arrangements do not guarantee an adequate pressing force for carrying the loads which occur in such luminaires. Finally ball-type detent arrangements can only be adjusted with difficulty.

Consequently, the invention seeks to provide a detent device which permits a sufficient transmission of force in a very small space and which in addition can be easily adjusted to the respective requirements involved.

The detent device according to the invention is characterised in that the direction in which the force of the pressure element acts is in the direction of the longitudinal extent of the connecting element.

In the installed position the connecting element extends transversely from the axis of rotation of the light guide element. In comparison with the ball-type detent arrangements which are known from the state of the art and in which the direction in which the force is operative usually extended in the longitudinal direction of the axis of rotation, laterally displaced therefrom, the direction in which the force of the detent device according to the invention acts is transversely with respect to the axis of rotation. Therefore, the direction in which the force of the spring and the pressure element extends, of the detent device according to the invention, also extends transversely with respect to the longitudinal direction in which the axis of rotation and the light guide element extends. That configuration means that substantially higher levels of torque can be carried by the detent device with a structural size which at the same time is smaller. Known ball-type detent arrangements would be difficult to fit in the constricted available structural space of the wall mounted luminaire according to the invention as they would have to be of very large dimensions in order to carry the forces involved, unattractive openings would have to be provided for passing screwdrivers for adjusting the ball-type detent arrangements in the light guide profile and ball-type detent arrangements would not have the required spring travels.

The connecting element can either be provided directly for carrying the spring and the pressure element or it can simply be in the form of a metal sheet profile member to which a spring sleeve can be fixed. The compression spring and the pressure portion are then fitted into that spring sleeve which is clipped in place. The pressure portion is biased when the connecting element is mounted between the light guide element and the casing. The spring is suitably dimensioned such that in the installed condition it is always in a biased condition and exerts the required pressing pressure on the pressure portion to carry the loads which occur.

To implement a predefined detent effect, it is advantageous to provide at least one blind hole, a detent groove or a similar positioning device in which the pressure portion is disposed in the installed position.

Preferably, provided on the rotatable light guide element is at least one arcuate segment, at the inner peripheral edge of which are provided a plurality of mutually spaced detent grooves or blind holes. That design configuration permits a detent retaining action at various, pre-defined discrete detent intervals.

The detent device according to the invention, in comparison with known ball-type detent arrangements, involves a markedly greater spring travel with a small structural size and can therefore substantially better compensate for the tolerances differences which occur. Adjustment which is required in the case of ball-type detent arrangements is completely eliminated by virtue of assembly in the stressed condition. That makes it possible to achieve particularly economical installation. As greater loads can be carried while involving a small structural size, the detent device according to the invention can be particularly advantageously used for the filigree-action wall mounted luminaire according to the invention, in the region of the head portions of the translucent wing profile members.

An advantageous embodiment of the luminaire according to the invention with the detent device according to the invention provided thereon is described hereinafter and illustrated in the Figures in which:

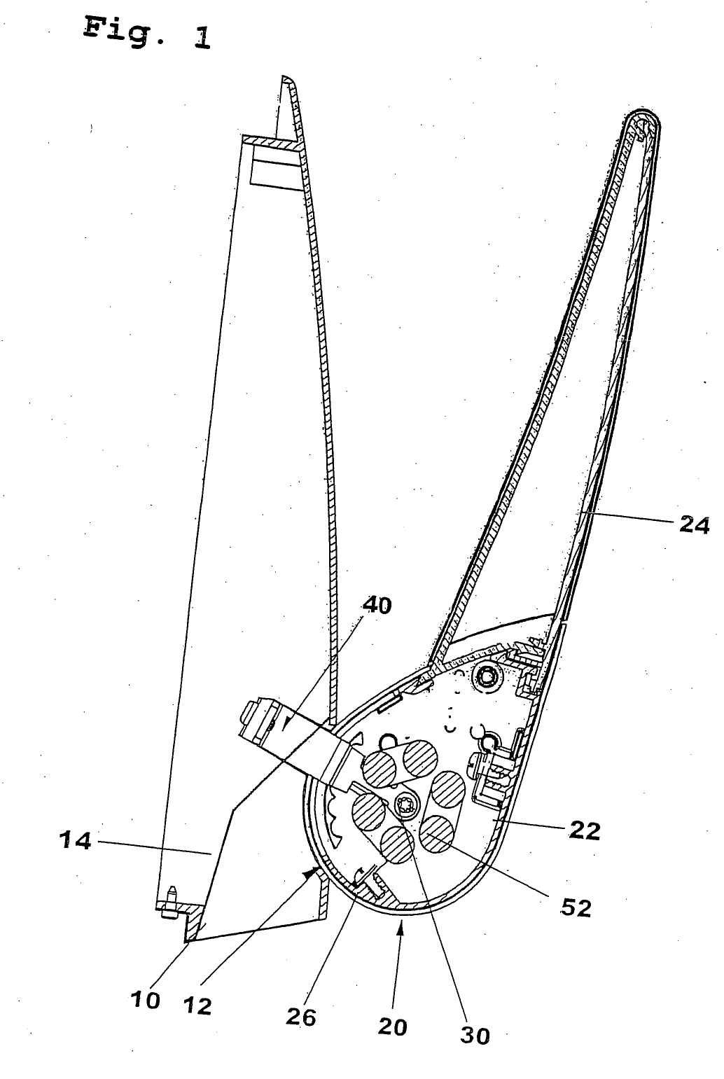

FIG. 1 is a side view in section through a wall mounted luminaire according to the invention with the wing profile member in the upwardly pivoted position,

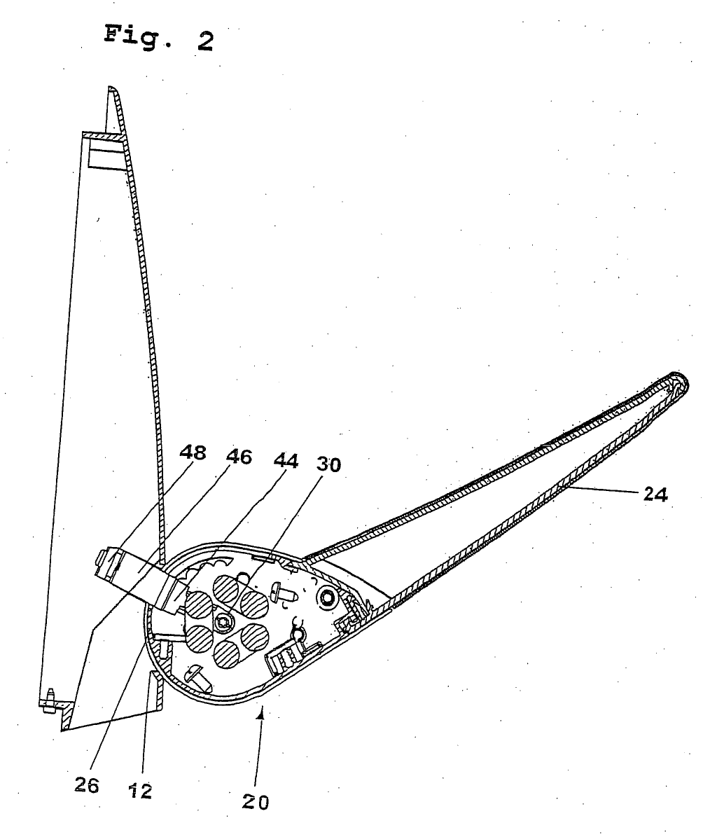

FIG. 2 is a view corresponding to FIG. 1 with the wing profile member in a downwardly pivoted position,

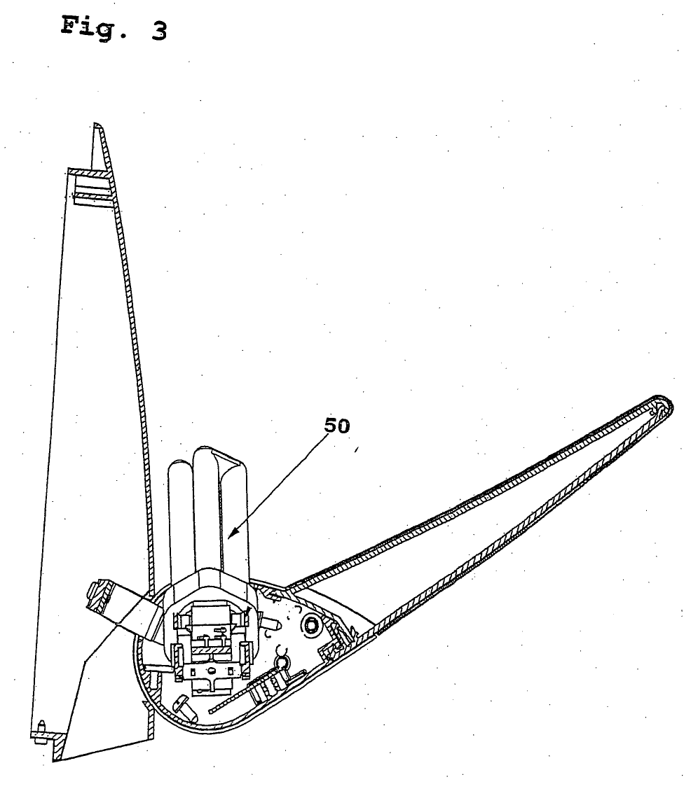

FIG. 3 is a view corresponding to FIG. 2 with the light means partially removed,

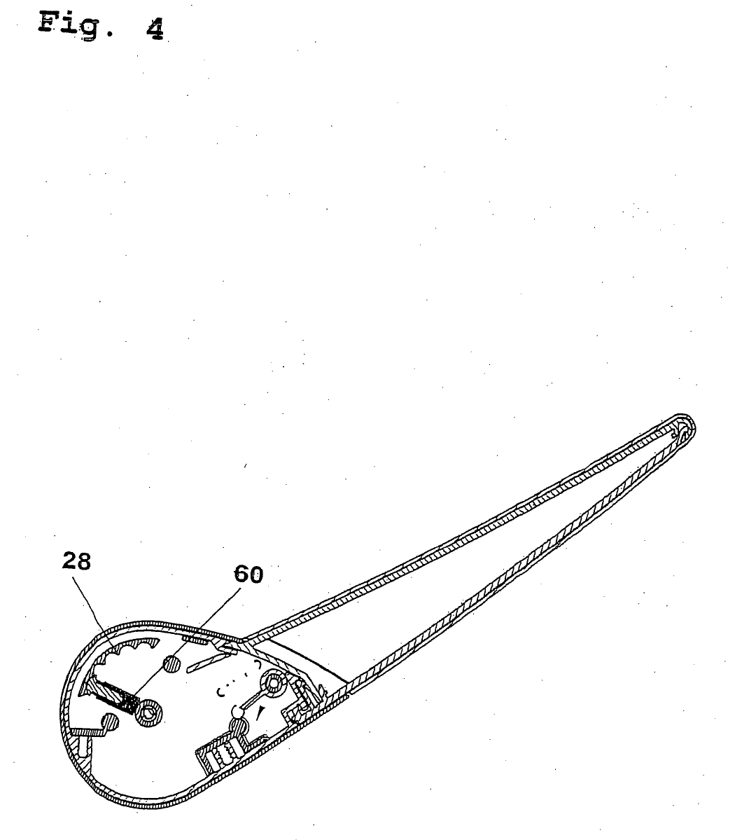

FIG. 4 is a side view in section through the light guide device with a detent device according to the invention arranged therein, in the downwardly pivoted position,

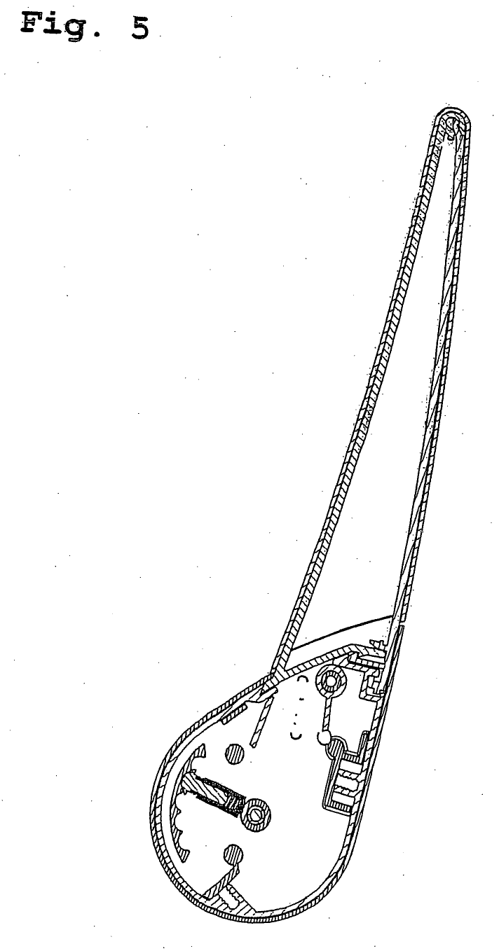

FIG. 5 is a view corresponding to FIG. 4 with the detent device in the upwardly pivoted position,

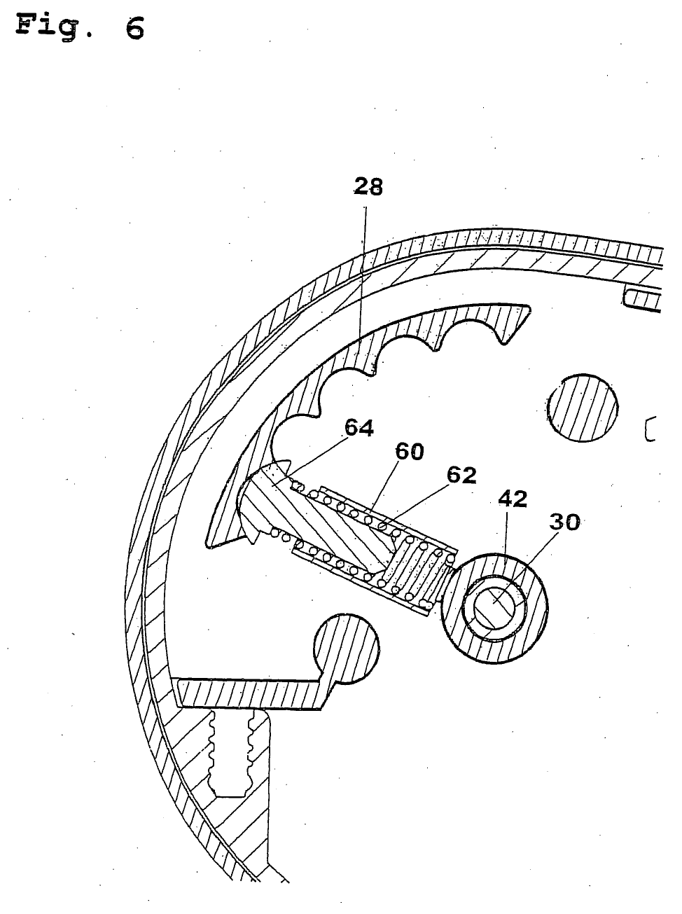

FIG. 6 is a view on an enlarged scale of the detent device, and

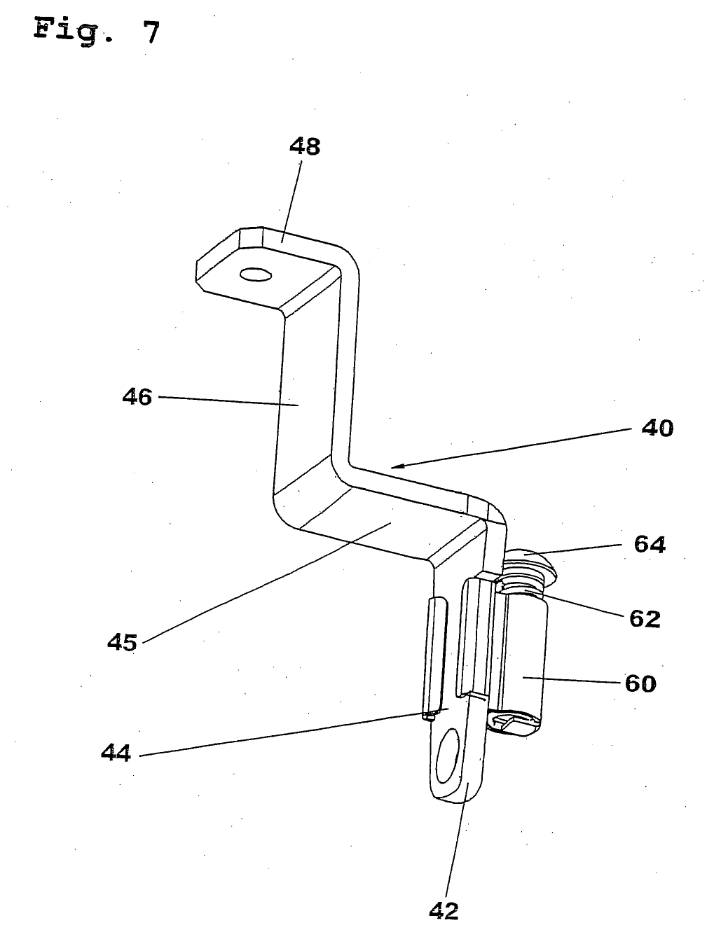

FIG. 7 is a perspective view on an enlarged scale of the detent device according to the invention.

Referring to the drawings, the wall mounted luminaire according to the invention substantially comprises a casing 10 which can be fixed to a wall and a wing profile member 20 which can be rotatably fixed to the casing and which in the present case represents the light guide element. The wing profile member 20 is connected to the casing 10 by way of two connecting elements 40 which are fixed to the two ends of the rotary shaft 30 and of which only one is visible in the Figures, by virtue of the sectional view therein.

The casing 10 is in the form of a plastic profile member which is wedge-shaped in cross-section and which increases in width in a downward direction. A light transmission opening 12 is provided in the lower end of the front side of the casing 10. In addition, an angled reflector 14 is arranged at the inside of the light transmission opening 12. The casing 10 is of an open configuration at its lower end.

The wing profile member 20 comprises substantially two elements, namely a metal sheet profile member 22 which is of a substantially drop-shaped configuration as viewed in cross-section and at the end of which, which converges in a point, a translucent plastic wing 24 is latchingly fixed. That plastic wing 24 is of a two-part nature.

Arranged in the metal sheet profile member 22 is a fluorescent lamp 50 which is fitted into a holder and of which only the section through the fluorescent tubes 52 is visible in FIGS. 1 and 2. The light produced by the fluorescent lamp 50 issues upwardly through the translucent wing profile member 20 to produce an indirect light flux. The luminaire thus produces the desired indirect component of the light.

FIG. 2 shows the wing profile member in the downwardly pivoted position. In that position, the arcuate slider 26 which is provided on the metal sheet profile member 22 covers over the light transmission opening 12 in the casing 10. In that way no light component issues downwardly through the light transmission opening 12 by way of the reflector 14 through the opening of the casing 10. Therefore the entire light flux is emitted in the form of an indirect light component through the plastic wing 24.

FIG. 1 in contrast shows the wing profile member 20 in the upwardly pivoted position. In that position the slider 26 exposes the light transmission opening 12 in the casing so that a part of the light flux generated by the fluorescent lamp 50 is deflected downwardly by way of the reflector 14 through the lower opening in the casing. That secondary light flux therefore illuminates the region beneath the luminaire.

Accordingly, the proportion of the deflected light flux can be varied as required by virtue of rotation of the wing profile member 20 in relation to the casing 10.

The opening in the casing 10 at the lower end thereof, when the fluorescent lamp 50 is switched on, draws in cool air in a chimney-like manner in order to cool the fluorescent lamp and the electrical system of the luminaire. In that way it is possible for the fluorescent lamp to be of a correspondingly smaller nature and to involve a higher wattage than a luminaire which would not have a chimney-like cooling arrangement of that nature.

As described hereinbefore the wing profile member 20 is fixed rotatably to the casing 10 by means of two connecting elements 40 which are arranged at the two ends in the region of the head portions and which in the installed position extend transversely with respect to the rotary shaft 30. Only one of those connecting elements 40 can be seen in FIGS. 1 through 3, by virtue of the position of the section. The precise structure of the connecting element 40 can best be seen from FIG. 7 in which it is shown on an enlarged scale. The connecting element 40 is fixed rotatably with a rotational end 42 to the rotary shaft 30 of the wing profile member 20. From that rotational end 42 the connecting element which is bent from a metal plate extends in the direction of the longitudinal extent in a first longitudinal limb 44. At the end of that limb 44 the sheet metal profile member goes into a transverse limb 45 transversely with respect to the longitudinal direction in which the connecting member extends, as viewing in the direction in FIG. 1, and, after that transverse limb 45, extends in the longitudinal direction again by way of a second longitudinal limb 46 to a fixing end 48 which is screwed to the casing 10. In a side view the connecting element 40 according to the invention appears substantially in the form of a Z-shaped metal profile member having a further transverse leg at the fixing end 48.

On the outside, that is to say in the direction of the head portion and covered in FIGS. 1 through 3 by the connecting element, a spring sleeve 60 is clipped on the connecting element 40. The spring sleeve 60 extends in the longitudinal direction in which the connecting element extends, on the first limb 44. Accommodated in that spring sleeve 60 is a compression spring 62 which bears at its lower end against the closed end of the spring sleeve 60 and which at its upper end carries a mushroom-shaped pressure element 64. In the installed position that pressure element 64 is clamped between the compression spring 62 and an arcuate segment 28 provided on the head portion of the wing profile member 20, in such a way that the mushroom-shaped head of the pressure element 64 fits in the blind holes provided in the inner peripheral edge of the arcuate segment 28. Upon rotation of the wing profile member 20 in relation to the casing 10 the spring force of the compression spring 62 is overcome so that the pressure element 64 jumps in detent retaining fashion from one blind hole to the next. In that situation however the required pressing force of the pressure element 64 is respectively maintained in such a way as to prevent unintentional rotary movement of the wing profile member 20, due to its own weight.

As the direction in which the pressure element 64 acts extends transversely with respect to the rotary shaft 30, the detent device according to the invention can carry markedly higher forces than ball-type detent arrangements which act in the direction of view, that is to say in the direction of the rotary shaft 30.

FIGS. 4 and 5 show the positions of the pressure element 64 with the wing profile member in the downwardly pivoted and upwardly pivoted positions. In the downwardly pivoted position as shown in FIG. 3 the fluorescent lamp 50 is particularly easily accessible and can be easily replaced.

It will be apparent to the man skilled in the art that the technology according to the invention can not only be used for indirect wall mounted luminaires but it can also be employed in relation to direct luminaires, the light flux of which is to be altered.

### List of references

10 casing
12 light transmission opening
14 reflector
20 wing profile member
22 metal sheet profile member
24 plastic wing
26 slider
28 arcuate segment
30 rotary shaft
42 rotary end
40 connecting element
44 first longitudinal limb
45 transverse limb
46 second longitudinal limb
48 fixing end
50 fluorescent lamp
52 fluorescent tubes
60 spring sleeve
62 compression spring
64 pressure element

1. A wall mounted luminaire, in particular for producing indirect light, comprising a casing for fixing to a wall and a light guide deice fixed rotatably to the casing with means for guiding a light flux emitted by a light means, wherein the light flux upon rotation is at least partially deflected by the means, characterized in that the means include a slider which upon rotation of the light guide device selectively opens or closes a light transmission opening in the casing.

2. A wall mounted luminaire as set forth in claim 1 characterised in that deflection of the light flux is variable in dependence on the angular position of the light guide device in relation to the casing.

3. A wall mounted luminaire as set forth in one of the preceding claims characterised in that the deflected light flux flows through the casing.

4. A wall mounted luminaire as set forth in one of the preceding claims characterised in that provided in the casing is a reflector for directing the light flux diverted thereinto.

5. A detent device for fixing a light guide element mounted pivotably about an axis of rotation in various detent positions, in particular for a wall mounted luminaire as set forth in one of the preceding claims, wherein the light guide element can be connected to a casing by way of at least one connecting element and there is provided a pressure element which is biased by a spring and which to implement the detent effect can be latched into one or more openings characterised in that the direction in which the force of the pressure element acts is in the direction of the longitudinal extent of the connecting element.

6. A detent device as set forth in claim 5 characterised in the that the connecting element is in the form of a metal sheet profile member to which a spring sleeve can be fixed.

7. A detent device as set forth in claim 5 or claim 6 characterised in that at least one blind hole or detent groove is provided on the light guide device.

8. A detent device as set forth in claim 5 or claim 6 characterised in that an arcuate segment with a plurality of detent grooves or blind holes is provided on the light guide device.
